(19) United States
(12) Patent Application Publication
(10) Pub. No.: US 2006/0006212 A1
(43) Pub. Date: Jan. 12, 2006

(54) Method of brazing composite material parts sealed with a silicon-based composition

(76) Inventors: Jacques Thebault, Bordeaux (FR); Clement Bouquet, Bordeaux (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/157,398

(22) Filed: Jun. 21, 2005

(30) Foreign Application Priority Data
Jun. 24, 2004 (FR) 04 06892

(51) Int. Cl. B23K 31/02

(52) U.S. Cl. 228/121; 228/186

(57) ABSTRACT

In order to prevent brazing composition from coming into contact with the silicon or other elements present in the materials of two parts made of thermostructural composite material that are being assembled together by brazing, a refractory ceramic material layer is formed at least on those surfaces of the parts that are to be united, which material is not reactive with silicon at brazing temperature.

### BACKGROUND OF THE INVENTION

The invention relates to assembling thermostructural composite material parts by brazing.

Structures made of thermostructural composite material and having complex shapes are difficult to make directly as single parts. It is generally preferred to build up a structure from elements that are of simple shape and that are assembled together, in particular by brazing.

In general, brazing is an assembly technique which consists in causing a metal-based composition to melt between the parts that are to be assembled together. The main advantage of brazing is that it enables the parts that are to be assembled together to be assembled without melting the materials constituting said parts, unlike welding. By way of example, amongst the brazing compositions or alloys that are commonly in use for assembling together parts of thermostructural composite materials, there are to be found alloys of silicon+metallic silicides, of silicon+optionally alloyed germanium, and also metallic compositions known under the trade names Cusil-ABA®, Ticusil®, Incusil®, and Brasic®.

Thermostructural composite materials are known for their good mechanical properties and their ability to conserve these properties at high temperature. They comprise composite materials constituted by reinforcement of refractory fibers densified by a matrix that is also refractory. As non-exhaustive examples, such materials include carbon-carbon (C/C) composites (reinforcement of carbon fibers densified by a matrix of carbon), and ceramic matrix composite (CMC) materials such as C/SiC composites (reinforcement made of carbon fibers and matrix made of silicon carbide), SiC/SiC composites (both fibers and matrix made of silicon carbide), C/C—SiC composites (reinforcement of carbon fibers and matrix comprising a carbon phase, generally closest to the fibers, and also a silicon carbide phase), C/C composites that have been silicided with gaseous SiO, liquid Si, etc.

The usual methods for obtaining parts of made of thermostructural composite material include the liquid technique and the gas technique.

The liquid technique consists in making a fiber preform having substantially the shape of the part that is to be made, and that is to constitute the reinforcement of the composite material, and in impregnating said preform with a liquid composition containing a precursor for the matrix material. The precursor is generally in the form of a polymer, such as a resin, possibly diluted in a solvent. The precursor is transformed into the refractory phase by heat treatment, after eliminating any solvent, and after curing the polymer. A plurality of successive impregnation cycles can be performed in order to achieve a desired degree of densification. By way of example, liquid precursors of carbon can be resins having a relatively high coke content, such as phenolic resins, whereas liquid precursors of ceramics, in particular of SiC, can be resins of the polycarbosilane type (PCS) or of the polytitanocarbosilane (PTCS) type or of the polysilazane (PSZ) type.

The gas technique consists in chemical vapor infiltration. The fiber preform corresponding to a part that is to be made is placed in an oven into which a reaction gas is admitted. The pressure and the temperature that exist inside the oven and the composition of the gas are selected in such a manner as to enable the gas to diffuse within the pores of the preform in order to form the matrix therein by a solid material being deposited in contact with the fibers as a result of a component of the gas decomposing or as a result of a reaction between a plurality of components of the gas. For example, gaseous precursors of carbon may be hydrocarbons that give carbon by cracking, e.g. methane, and a gaseous precursor of ceramic, in particular SiC, may be methyltricholorosilane (MTS) which gives SiC by the MTS decomposing (possibly in the presence of hydrogen).

There also exist combined techniques using both the liquid technique and the gaseous technique.

Nevertheless, whatever the method of densification that is used, parts made of thermostructural composite material always present residual porosity due to the inevitably incomplete nature of the densification of fiber preforms. Typically, with no particular treatment during densification, parts present pores having a minimum volume content of about 10%. Such porosity represents the presence of pores and/or cracks of greater or smaller dimensions, which communicate with one another, and which open out to the surface of the part.

As shown very diagrammatically in FIG. 1, two parts 1 of 2 of thermostructural composite material M are assembled together by brazing by interposing a brazing layer 3 between the surfaces S1 and S2 of the parts that are to be untied. However, because of the porous nature of the material from which the parts are made, a fraction of the brazing composition 3 interposed between the parts 1 and 2 penetrates into pores P in the material via holes that open out into the surfaces of the parts, thereby leaving localized portions 4 that do not have any brazing composition between the two surfaces. This lack of composition leads to defective bonding between the two parts, and consequently to an assembly of degraded quality.

A known solution to that problem consists in filling in the pores of the thermostructural composite material parts by siliciding, i.e. by introducing into the material a composition based on molten silicon. That type of siliciding is known in itself and is described in particular in the following documents: FR 2 653 763, U.S. Pat. No. 4,626,516, EP 0 636 700, and FR 03/01871.

Nevertheless, although thermostructural composite materials, once silicided in that way, can be considered as being sufficiently impermeable to retain the brazing composition on the surface, the presence of one or more silicide phases within the material leads to another problem.

Most of the alloys used for brazing purposes, and mentioned above, contain a significant fraction of metallic components corresponding to transition metals (e.g. Cu, Fe, Ni, Mn, etc.) that react with silicon, leading to the formation of naturally brittle metallic silicides in the bond.

Furthermore, when using a brazing composition that is not reactive or that presents controlled reactivity, of the kind implemented in BraSiC® technology, there is interdiffusion at brazing temperatures (about 1400° C.) between the brazing composition and the silicon present in the pores of the material, such that the expected physico-chemical transformation for forming the bonding between the parts is no longer controlled. Direct contact between the silicon of the material and the brazing composition can change the proportions of the brazing composition components by diffusion in the liquid state during brazing, thereby modifying its properties.

Furthermore, with silicided thermostructural composite materials that are assembled together by brazing, another problem arises when reworking or repairing the bond. If two silicided thermostructural composite material parts are poorly assembled, either initially or following weakening or an attack on the brazing joint, it must be possible to remove the remaining brazing material, to clean the parts, and then to braze them back together again properly. Removing the brazing composition and cleaning the parts requires treatment in a corrosive bath (acid or alkaline) which also attacks the residual silicon of the silicided part. Under such conditions, any disassembly of a bond made by brazing between two parts of silicided thermostructural composite material makes the parts non-reusable, which is penalizing in terms of expense and/or recycling.

### OBJECT AND SUMMARY OF THE INVENTION

The invention seeks to provide a method enabling parts of thermostructural composite material to be assembled together by brazing, in which at least the surfaces for putting into contact have been sealed by being impregnated with a silicon-based composition, while avoiding the above-mentioned drawbacks, and in particular preventing any reaction or diffusion between the brazing composition and the silicon present in the material of the parts.

According to the invention, this object is achieved by a method in which, after the sealing step and prior to the brazing step, a layer of refractory ceramic material is formed at least on those surfaces of the parts that are to be united, which ceramic material is not reactive with silicon at brazing temperature. Such a material may be selected in particular from ceramics that are derivatives of silicon, such as silicon nitride (Si₃N₄) or silicon carbide (SiC).

Thus, the brazing composition need not come into contact with the silicon or other elements present in the material, since a layer of refractory ceramic is protecting the surface of the material to be brazed.

The risks of reaction or diffusion between the brazing composition and the silicon of the material are thus avoided, thereby making it possible to control brazing better and to obtain a bond between the two parts that is uniform and of good quality.

Furthermore, the ceramic, e.g. silicon carbide, withstands corrosion well, so in the event of the bond being reworked or repaired, it is possible to attack the brazing composition with corrosive chemicals while not damaging the material of the parts.

The ceramic layer may be formed by chemical vapor deposition or by chemical gas infiltration.

The surface of the ceramic layer formed on the surfaces of the parts can be lapped prior to brazing. The mean thickness of the ceramic layer preferably lies in the range 1 micrometer (μm) to 100 μm, being about 50 μm, for example.

The brazing composition used is preferably based on a metal that is not reactive or that presents controlled reactivity relative to the ceramic which covers the surfaces of the parts to be united.

In a particular embodiment, prior to the brazing step, an antiwetting agent is applied to those portions of the parts that are to be brazed together so that the brazing composition wets only those surface portions that are to be assembled together.

In another embodiment, the liquid brazing composition is transported by capillarity to a position between the parts to be united by means of a wick, e.g. constituted by carbon fibers, in order to convey the brazing composition by capillarity between the two parts that are to be united.

### BRIEF DESCRIPTION OF THE DRAWINGS

Other characteristics and advantages of the invention appear from the following description of particular embodiments of the invention, given as non-limiting examples, with reference to the accompanying drawings, in which:

FIG. 1, described above, is a highly diagrammatic view of the result obtained when brazing together two porous thermostructural composite material parts;

FIG. 2 is a flow chart showing the successive steps of an implementation of a method of the invention;

FIG. 3 is a diagram showing a portion of a thermostructural composite material part sealed by siliciding and after a layer of silicon carbide has been deposited on its surface;

FIG. 4 is a diagram of the same portion as shown in FIG. 3, after the layer of silicon carbide has been lapped;

FIG. 5 shows how brazing can be performed between two parts while using a capillary wick; and

FIG. 6 is a diagram showing the structure that is obtained after brazing together two parts in accordance with a method of the invention.

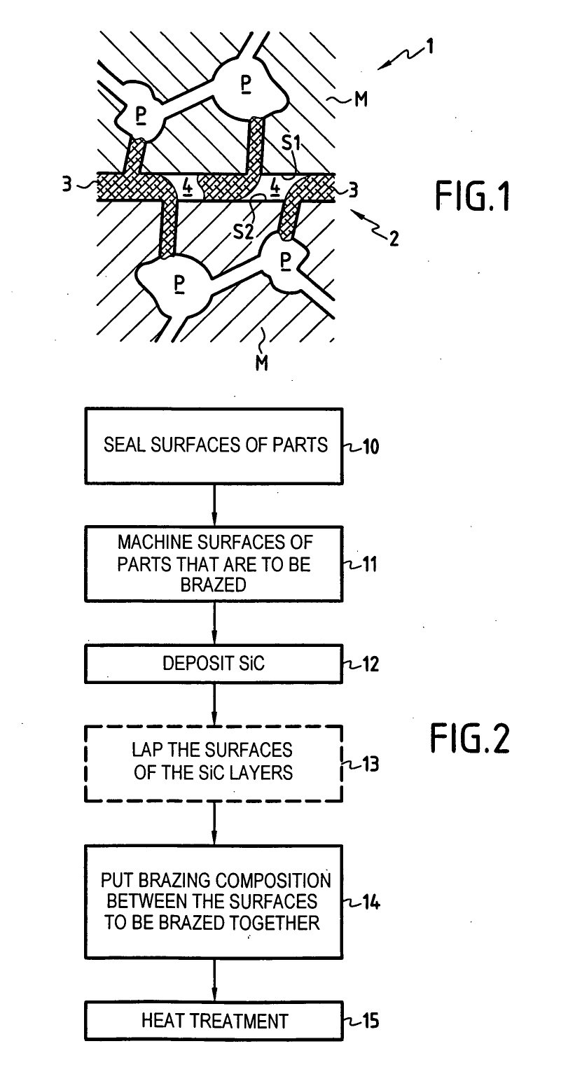

### DETAILED DESCRIPTION OF AN IMPLEMENTATION

The brazing assembly method of the present invention applies to any type of silicided thermostructural composite material, i.e. to any material comprising refractory fiber reinforcement densified by a matrix that is also refractory, such as C/C materials, or CMC materials, and in particular C/SiC, SiC/SiC, C/C—SiC, etc. materials.

With reference to FIG. 2, an implementation of a method in accordance with the invention for brazing together two parts made of thermostructural composite material that have been sealed by siliciding, comprises the following steps.

A first step (step 10) consists in sealing the thermostructural composite material of the parts, at least on those surfaces that are to be put together, filling in the pores by impregnating them with a composition based on molten silicon. The composition based on silicon may be constituted by silicon or by a silicon alloy (e.g. SiGe), and at least one other material selected in particular from: iron, cobalt, titanium, zirconium, molybdenum, vanadium, carbon, and boron. Impregnating thermostructural composite materials with a silicon-based composition is a technique that is known in itself, and it is described in particular in the following documents: FR 2 653 763, U.S. Pat. No. 4,626,516, EP 0 636 700, and FR 03/01871.

The second step (step 11) consists in preparing these surfaces of the two parts that are to be brought together. For this purpose, the contact surfaces of the parts are machined so as to adapt the shape of the docking plane between the two parts.

Once the surfaces have been machined, a refractory ceramic layer is deposited on at least one of the surfaces that is to be brazed (step 12). The refractory ceramic is selected to be a material that is not reactive with silicon at the brazing temperature. In general, any ceramic corresponding to a derivative of silicon, such as Si₃N₄ or SiC can be used to protect the surfaces of parts that are to be brazed together. In the example described herein, SiC is deposited. This deposition may be performed by chemical vapor deposition (CVD) or by chemical vapor infiltration (CVI). In either case, deposition takes place in an oven into which a gaseous precursor of silicon carbide, such as methyltrichlorosilane (MTS) is admitted so as to give silicon carbide by the MTS decomposing, possibly in the presence of gaseous hydrogen (H₂). The natures of the reaction gases and the pressure and temperature conditions needed for obtaining silicon carbide deposits by chemical vapor deposition or chemical vapor infiltration are themselves well known.

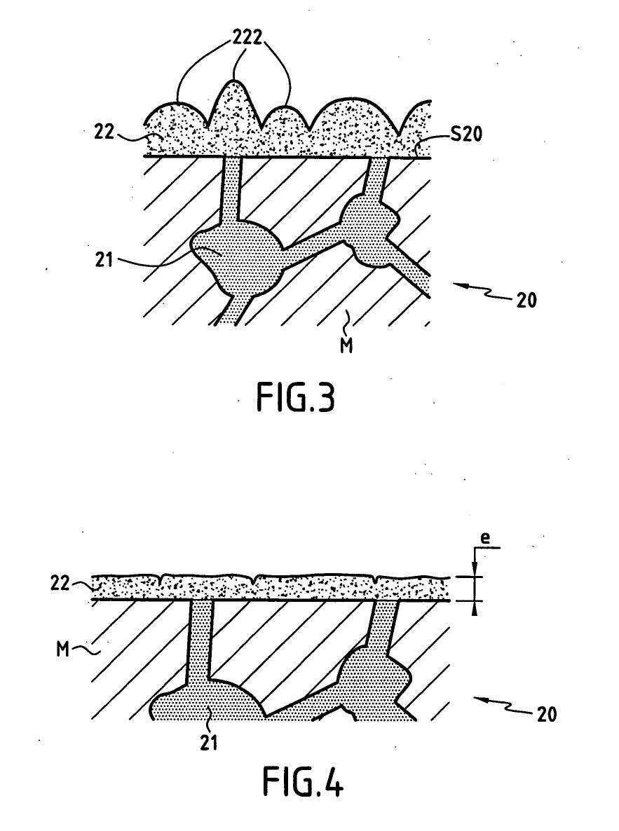

As shown very diagrammatically in FIG. 3, which shows a fraction of a part 20 of thermostructural composite material M in which the pores have been filled in, e.g. by being impregnated with a molten composition based on silicon 21, the surface S20 of the part 20 that is to be brazed to the corresponding surface of another part is covered in a layer of silicon carbide 22.

This forms a protective layer on the surface of each part that is to be brazed, which layer serves to prevent brazing composition from coming into contact with the silicon that is present at the surfaces of the parts during a subsequent brazing operation.

Although the process used for depositing the ceramic (i.e. chemical vapor deposition or chemical vapor infiltration) makes it easier to control the thickness of the resulting deposit, it can nevertheless happen that microrelief 222 (surface nodules) can appear on the surface of the silicon carbide layer 22 as formed in this way.

Under such circumstances, once the ceramic layer has been deposited, its own surface can be lapped (step 13) in order to eliminate the larger roughnesses by abrasion, while nevertheless not attacking the dense layer of ceramic sufficiently to pierce it. As shown in FIG. 4, a layer of carbide is obtained that is substantially plane, preferably presenting mean thickness e lying in the range 10 μm to 100 μm, being about 50 μm, for example. Such a thickness is obtained by controlling the quality of ceramic, in this case SiC, that is deposited, while also taking account of lapping, if any.

Thereafter, these two parts are assembled together by brazing. In conventional manner, the brazing operation comprises two main steps, namely interposing a brazing composition between the surfaces of the part that are to be united one against the other (step 14), and heat treatment (step 15) that corresponds to raising the temperature above the melting temperature of the brazing composition.

In a first brazing technique, the composition may be deposited directly on the surfaces that are to be united. In another technique, the composition may be conveyed between the parts by capillarity. For this purpose, and as shown in FIG. 5, a “dry” (i.e. non-impregnated) wick 50, e.g. of drain-forming carbon fibers, is interposed between two parts 20 and 30 of thermostructural composite material M having respective surfaces S20 and S30 covered in silicon carbide layers 22 and 32. One end of the wick is immersed in a crucible 60 containing a brazing composition 61. Thereafter, the temperature is raised until the brazing composition 61 becomes liquid, whereupon it is sucked by capillarity along the wick 50 and distributed over the entire area for brazing between the two parts where they are in contact with the wick.

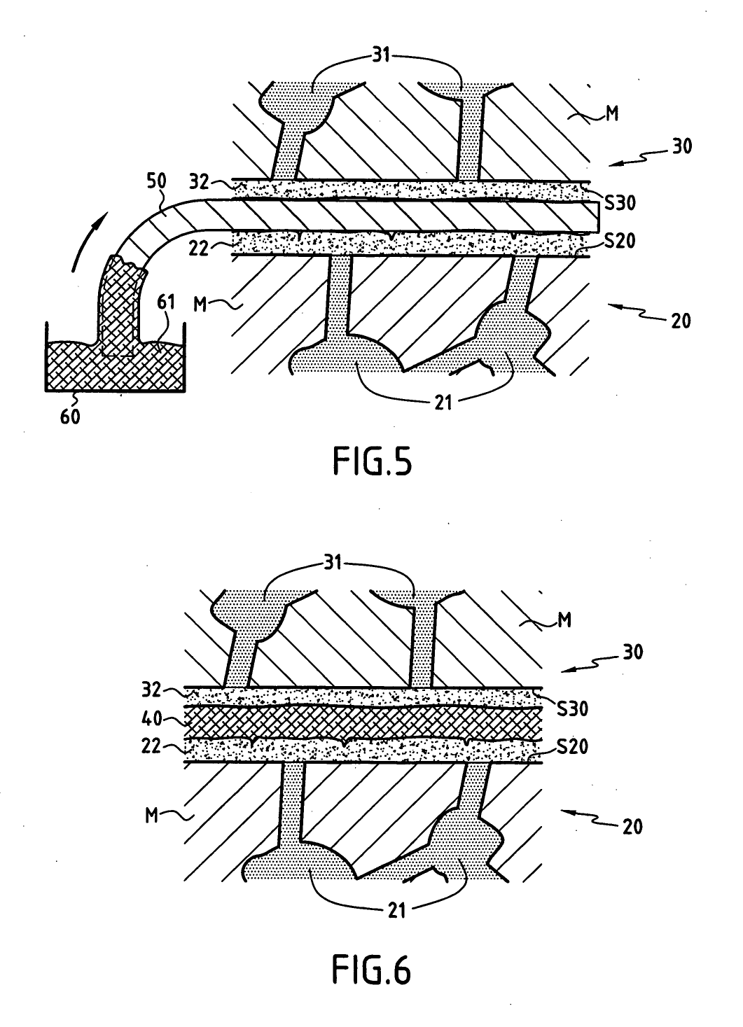

As shown very diagrammatically in FIG. 6, this provides a joint 40 of brazing composition between the two parts 20 and 30, serving to bond them together. Since, in accordance with the present invention, the surfaces S20 and S30 respectively of the parts 20 and 30 are covered in layers of silicon carbide 22 and 32 prior to brazing, there is no direct contact between the brazing composition and the silicon 21, 31 present at the surfaces of the parts 20 and 30.

When assembling together two parts presenting contact surfaces that are discontinuous or of complex shape, an antiwetting agent may be deposited on those zones of the parts that are not to be brazed so as to control the flow of brazing composition so that it wets only those zones of the parts that are to be brazed. By way of example, the antiwetting agent used may be boron nitride (BN) prepared in the form of an aerosol spray, or the so-called “Stop-Off” products such as the antiwetting agent Stopyt® sold by the supplier Wesgo Metals, or Nicrobraz® products sold by the supplier Wall Colmonoy Limited.

Such an antiwetting agent may be used, for example, when fabricating heat exchangers such as those used in the walls of the diverging portion of a thruster nozzle that is cooled by fluid circulation. That type of heat exchanger can be obtained by brazing together two panels of thermostructural composite material, as described in document FR 03/01039, with at least one of the panels having grooves to form fluid circulation channels. Prior to the brazing operation, an antiwetting agent is placed on those zones of the panels that are not to be brazed together, e.g. the grooves. The brazing composition can then be deposited in approximate manner over the entire area of the faces to be assembled together, with the composition subsequently migrating onto those zones that are not covered in the antiwetting agent. After brazing, the antiwetting agent can itself be removed by circulating an acid or any other agent, depending on the indications given by the supplier of the antiwetting agent.

The brazing composition is selected in particular as a function of its compatibility with silicon carbide, i.e. it is preferable to select a composition that is not reactive or that presents controlled reactivity with silicon carbide. For example, it is possible to use compositions based on silicon, such as those described in European patent application EP 0 806 402 or U.S. Pat. No. 5,975,407, alloys of silicon+metallic silicides, of silicon+optionally alloyed germanium, and metallic compositions known under the following trade names: Cusil-ABA®, Ticusil®, Incusil®, or Brasic®.

Consequently, the method of the invention enables silicided thermostructural composite material parts to be brazed together without any risk of interaction and/or diffusion between the brazing composition and the silicon present in the material. This ensures that a good quality bond is formed between the parts.

In addition, the refractory ceramic coating enables the material of the parts to be surface protected against oxidation, while leaving no apparent silicon. Furthermore, when the ceramic deposited on the surface of such a part withstands higher temperatures than silicon, it is possible to use brazing compositions having melting temperatures that are higher than is possible when the silicon is itself directly exposed at the surface of the part.

What is claimed is:

1. A method of assembling together two parts of thermostructural composite material by brazing, the method including a prior step of sealing at least those surfaces of the parts that are to be united, with sealing being performed by impregnating the parts with a silicon-based composition,
wherein, after the sealing step and prior to the brazing step, a layer of refractory ceramic material is formed at least on those surfaces of the parts that are to be united, which ceramic material is not reactive with silicon at brazing temperature.

2. A method according to claim 1, wherein the ceramic material is silicon carbide or silicon nitride.

3. A method according to claim 1, wherein, prior to the step of forming the layer of ceramic material, the surfaces of the parts to be assembled together are machined so as to define the shape of the docking zone between the two parts.

4. A method according to claim 1, wherein the refractory ceramic material layer is formed by chemical vapor deposition.

5. A method according to claim 1, wherein the refractory ceramic material layer is formed by chemical vapor infiltration.

6. A method according to claim 1, wherein the surface of the refractory ceramic material layer formed on the surface of each of the parts is lapped.

7. A method according to claim 1, wherein the refractory ceramic material layer presents a mean thickness lying in the range 1 μm to 100 μm.

8. A method according to claim 7, wherein the refractory ceramic material layer presents a mean thickness of about 50 μm.

9. A method according to claim 1, wherein the brazing composition used during the brazing step is a metal-based composition that is not reactive with or that presents controlled reactivity with the refractory ceramic material.

10. A method according to claim 1, wherein, prior to the brazing step, it further comprises applying an antiwetting agent on those portions of the parts that are not to be brazed.

11. A method according to claim 1, wherein, prior to the brazing step, the brazing composition is transported by capillarity by means of a wick disposed between the surfaces of the parts that are to be united.
